(19) United States
(12) Patent Application Publication
(10) Pub. No.: US 2005/0157483 A1
(43) Pub. Date: Jul. 21, 2005

(54) Lenticular medium with electro-luminescent backlighting

(76) Inventors: Philip Chan, San Marino, CA (US); Timothy Aiu, Chino Hills, CA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 10/874,626

(22) Filed: Jun. 23, 2004

Related U.S. Application Data
(60) Provisional application No. 60/482,168, filed on Jun. 24, 2003.

(51) Int. Cl. F21V 9/16

(52) U.S. Cl. 362/84; 362/255; 362/335

(57) ABSTRACT

An improved system for backlighting a visual effect of interest is presented. The system includes a lenticular luminescent lens, an electroluminescent (EL) light source and a power source coupled to the EL light source. The lenticular luminescent lens includes a luminescent substance disposed thereon/therein for providing the visual effect of interest when exposed to stimulating light. The EL light source is affixed to a surface of the lenticular luminescent lens. When the power source applies power to the EL light source, the EL light source activates an area of illumination backlighting the visual effect of interest.

### CROSS-REFERENCE TO RELATED CASES

This patent application is claims priority to commonly owned U.S. Provisional Patent Application Ser. No. 60/482,168 (Attorney's Docket No.102445-100) entitled “LENTICULAR MEDIUM WITH ELECTRO-LUMINESCENT BACKLIGHTING” that was filed on Jun. 24, 2003. The disclosure of U.S. Patent Application Ser. No. 60/482,168 (Attorney's Docket No. 102445-100) is incorporated by reference in its entirety herein.

### BACKGROUND OF THE INVENTION

1. Field of the Invention

The present invention relates generally to lighting systems for advertising and entertainment media and, more particularly, to backlighting lenticular medium employed in such media with an electro-luminescent device.

2. Description of Prior Art

It is well known to use a lenticular luminescent material as a display element in display systems. Generally speaking, the lenticular luminescent material includes a substrate containing a luminescent substance that is capable of fluorescence in response to stimulating light such as, for example, ultraviolet radiation, visible light, near-infrared radiation and the like. One such lenticular luminescent display element is described in U.S. Pat. No. 5,021,931, issued Jun. 4, 1991, to Fumio Matsui et al., the disclosure of which is incorporated by reference herein in its entirety.

Lenticular luminescent materials may be used to provide animated and three-dimensional (3-D) graphics in the advertising and entertainment industries and is commonly employed, for example, in signage, postcards, compact disc mailer covers, pop ups, stickers, cups, key chains, sew-on appliqués, buttons and trading cards.

One perceived disadvantage of conventional lenticular luminescent material is that as luminescent light is emitted from the material it is scattered in every direction. Therefore, the efficiency with which an applied stimulating light is utilized is low as is the intensity of luminescent light emitted from the material. As a result, the graphics provided by the lenticular luminescent material is relatively dark when viewed by an observer.

The present invention provides a solution to this deficiency by utilization of electroluminescent (EL) lamp.

Conventional EL lamp manufacturing techniques may be divided into two basic processes. The first, a screen-printing process in which a lamp is constructed layer by layer. More particularly, the lamp is constructed using the steps of making indium tin oxide (ITO) plated plastic film; applying EL phosphor ink on the ITO plating to form lighted areas; applying capacitive dielectric ink over the EL phosphor ink; applying electrically conductive ink over the capacitive dielectric ink to form a second capacitive plate; applying electrically conductive ink over the ITO plated plastic film outboard of the capacitive dielectric ink layer to provide a front capacitive electrode connection. This first construction is typically protected from environmental attack by means of either an encapsulating lamination, or secondarily by application of a water repellant electrical insulating coating containing an ultraviolet light activated polymer. An example of this method of manufacturing is described in U.S. Patent Application Publication No. 2003/0003837, which is incorporated by reference herein in its entirety.

The screen-printing process allows intricate graphics effects to be created using relatively simple manufacturing processes. However, screen-printed EL lamps having high luminance or superior electrical characteristics tend to be costly to manufacture. This is due in part to the difficulty of precisely aligning all conductive, insulating and light emissive layers when processing is performed with typical screen-printing methods. Such layer-to-layer alignment difficulties can result in decreased production yields, especially in applications where there is limited space to provide electrical clearance between the rear electrode and front electrode connection described above.

The second common process is a laminated EL lamp assembly. In this process, a first film, which supports a metal foil, is passed below a metering roller or blade that applies an insulating layer of capacitive dielectric ink. A second, light transmissive ITO plated film is similarly passed below a roller or blade, which applies a layer of EL phosphor ink onto the ITO plating. In order to achieve both a uniform light output and reliable electrical characteristics, the thickness of the insulating dielectric and phosphor layers must be precisely controlled, along with the grain dispersion of the EL phosphor particles within the phosphor layer. This typically continuous lamination requires tight control over both ink rheology and ink application processes. An improved example of this manufacturing method is described in U.S. Pat. No. 5,667,417, which is incorporated herein by reference in its entirety.

Once the ink layers have dried and been inspected for defective areas, the first and second films are laminated together to form an EL lamp core. This film lamination method requires heat and/or pressure, which must be tightly controlled so that the light and electrical characteristics of the finished lamp are consistent. Additionally, since the EL phosphor layer is sensitive to water contamination, once the finished lamp is cut into usable shape and size and electrically terminated, it is then encapsulated within a moisture resistant lamination film.

The continuous lamination method produces foil EL lamps, which are high performance, high priced lamps typically unsuitable for complex graphics or other price sensitive applications. Laminated foil EL lamps are also typically thicker and less flexible than screen printed lamps, limiting their application to those where flexibility and thickness are of less concern.

In both of the above methods, metal and metal oxides are plated upon a plastic carrier film that is typically used as the basis material for the front conductive layer. The usual film of choice is polyester plastic film plated with ITO. This particular plating exhibits the additional construction weakness of fracturing under close bend radius flexing. These fractures have been demonstrated to cause both dimmed areas, and even total non-illumination of EL lamps of these constructions, due to the interrupted current path at the location of breakage.

In copending U.S. patent application Publication No. 2003/0003837, a low cost method for manufacturing water resistant EL lamps for consumer applications is described. The inventors have realized that an EL lamp manufactured in accordance with this copending application may be used to backlight lenticular luminescent material and to solve the aforementioned disadvantage (e.g., relatively dark displays) of using such materials in, for example, products for the advertising and entertainment industries.

The inventors have also realized that an EL lamp manufactured using a screen printable ITO paste or powder directly on substrates such as, for example, treated (e.g., heat treated) or untreated polyester, fabrics, plastics, leather, cloth and polycarbonates as the rear or front electrode may be used to manufacture electroluminescence to solve the aforementioned disadvantage. In another embodiment, the ITO paste or powder may be applied directly onto the Lenticular medium.

### SUMMARY OF THE INVENTION

The above and other objects are achieved by an improved system for backlighting a visual effect of interest. One aspect of the present invention is drawn to a system for backlighting a visual effect of interest, comprising:
a lenticular luminescent lens having a luminescent substance disposed thereon and/or therein for providing said visual effect of interest when exposed to stimulating light;
an electroluminescent (EL) light source affixed to a surface of said lenticular luminescent lens for providing an area of illumination about said visual effect of interest; and
a power source coupled to said EL light source;
wherein when said power source applies power to said EL light source, said EL light source activates said area of illumination backlighting said visual effect of interest.

### BRIEF DESCRIPTION OF THE DRAWINGS

The features and advantages of the present invention will be better understood when the Detailed Description of the Preferred Embodiments given below is considered in conjunction with the figures provided, wherein:

FIG. 1 is an exploded, isometric view of a backlit lenticular assembly constructed in accordance with one embodiment of the present invention;

FIG. 2A is a cross sectional, side view of one embodiment of the backlit lenticular assembly of FIG. 1;

FIG. 2B is a cross sectional, side view of another embodiment of the backlit lenticular assembly of FIG. 1; and

FIG. 3 is a top, plan view of the backlit lenticular assembly of FIG. 1.

Like reference numbers and designations in the various drawings indicate like elements.

### DETAILED DESCRIPTION OF THE PREFERRED EMBODIMENTS

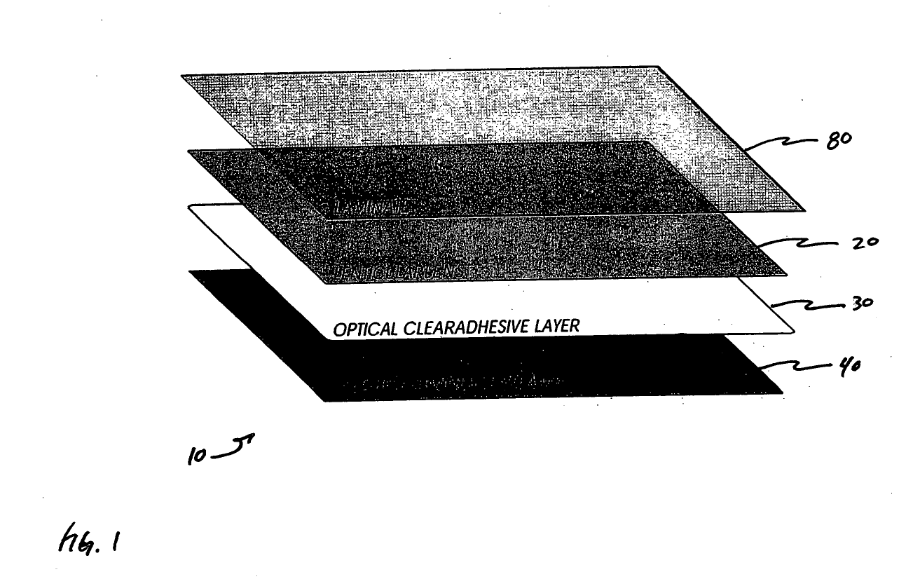

FIG. 1 is an exploded, isometric view of a backlit lenticular assembly 10 formed, in accordance with one embodiment of the present invention, as a layered construction including a lenticular luminescent lens 20, an optical adhesive 30 and an EL light source 40. In one embodiment, the assembly 10 includes a laminate top coating or layer 80 providing protection from environmental and/or other hazards.

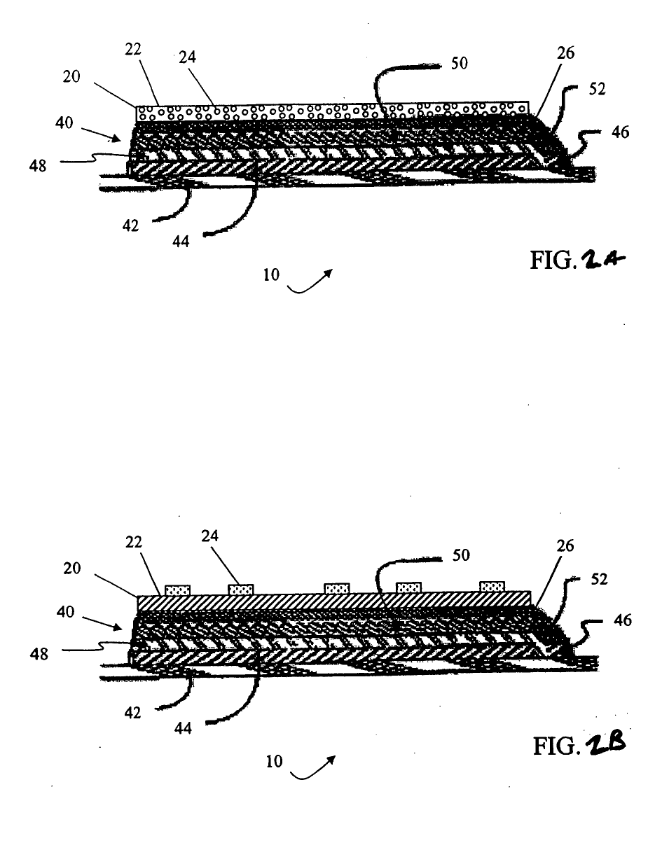

FIGS. 2A and 2B are cross-sectional, side views of the backlit lenticular luminescent assembly 10 of FIG. 1. As shown in FIGS. 2A and 2B, the optical adhesive layer 30 affixes the lenticular luminescent lens 20 to a surface of the EL light source 40.

The lenticular luminescent lens 20 includes a material such as, for example, a transparent synthetic resin material 22 having a luminescent substance 24 such as, for example, benzoyltrifluoroacetone or the like, mixed therein (FIG. 2A) and/or applied thereto (FIG. 2B). In one embodiment, the luminescent substance 24 may also include polycarbonate, polyvinyl chloride or polyesters or more than one of these. The resin material 22 is transparent to facilitate backlighting as is described below.

In accordance with one aspect of the present invention, the luminescent substance 24 is either mixed within or applied to the surface of synthetic resin material 22 or both such that a visual effect of interest is apparent to an observer when the substance 24 is exposed to stimulating light. In one embodiment, the visual effect is one of the aforementioned graphics for use in the advertising or entertainment industries. In another embodiment, the visual effect is a 3-D effect that varies in relation to a position of an observer.

In one embodiment, the EL light source 40 is an EL lamp having a low electric current consumption, good mechanical durability and sufficient flexibility to bent and conform to curved surfaces. Preferably, the EL light source 40 emits light evenly over a wide area rather than from a point source. This permits production of unique construction for improving both daytime and nighttime visibility as described herein.

In one embodiment, the EL light source 40 is an EL lamp constructed in accordance with the method of manufacture described in the aforementioned, copending U.S. patent application Publication No. 2003/003837. In this embodiment, illustrated in FIGS. 2A and 2B, the EL light source 40 includes a plastic film or paper core stock 42, a capacitive electrode layer 44, a front capacitive electrode power distribution bus 46, a capacitive dielectric insulation layer 48, an EL phosphor layer 50, and a light transmissive electrically conductive layer 52.

As shown in FIGS. 2A and 2B, various layers of EL light source 40 encapsulate lower layers. For example, the capacitive dielectric insulation layer 48 is allowed to fill a gap between the rear capacitive electrode 44 and the front capacitive electrode power distribution bus 46. Also, while EL phosphor layer 50 is allowed to bleed beyond edges of the rear capacitive electrode 44, it does not contact the front capacitive electrode power distribution bus 46, and in conjunction with the dielectric insulation layer 48, provides electrical isolation between layers the capacitive electrode 44 and the light transmissive electrically conductive layer 52. Additionally, the light transmissive electrically conductive layer 52 contacts the front capacitive electrode power distribution bus 46 making electrical connection between the conductive layer 52 and the power distribution bus 46.

In one embodiment, the EL light source 40 also includes a light transmissive polyester film environmental encapsulation (not shown). The light transmissive polyester film environmental encapsulation bleeds beyond all lower layers and extends onto the core stock 42, providing both an electrical safety isolation and an environmental attack resistant encapsulating envelope.

In yet another embodiment, the EL light source 40 is comprised of an ITO paste or powder applied directly (e.g., by silk screening or by disposition) to a surface of the lenticular luminescent lens 20. For example, in one embodiment wherein the lens 20 is comprised of a treated (e.g., heat treated) or untreated polyester, fabric, plastic, leather, cloth or polycarbonate, an ITO paste or powder is applied to a surface of the lens 20. The inventors have discovered that the use of ITO paste or powder as an EL lamp provides improved illumination of the visual effects of interest. For example, the ITO paste or powder is more flexible and can permits application of the EL light source 40 to the surface of the lenticular lens 20 via an iron on decal appliqué. One supplier of suitable ITO paste or powder is Read Advanced Materials of Providence, R.I., USA. In one embodiment, the composition of the lens 20 is ninety percent (90%) ITO powder and ten percent (10%) zinc mixed into a resin binder.

In one embodiment, the ITO paste or powder is applied to the lenticular lens by using a screen printing process that is similar to a roll to roll manufacturing process using digital optics, and xyz and theta registration, as described in the aforementioned, copending U.S. patent application Publication No. 2003/003837.

As shown in FIGS. 1, 2A and 2B, the EL light source 40 is affixed to a surface of the lenticular luminescent lens 20, e.g., a bottom surface 26 of the lens 20, to backlight the visual effect of interest. It should be appreciated that the EL light source 40 may illuminate an entire surface of the lenticular luminescent lens 20 or a portion thereof, as desired by a particular implementation or embodiment of the present invention.

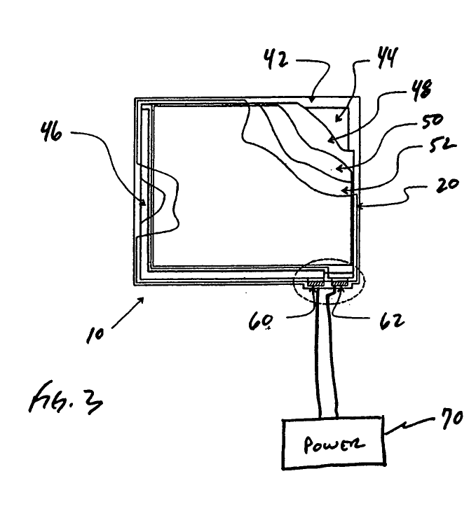

FIG. 3 illustrates a top, plan view of the backlit lenticular luminescent assembly 10. As shown in FIG. 3, the rear capacitive electrode 44 and the EL phosphor layer 50 define a rectangular area of illumination. It should be appreciated, however, that the specific shape of the area of illumination is not limited to a rectangular configuration. As such, it is within the scope of the present invention for the area of illumination to include other geometric shapes such as, for example, circles, squares, triangles and portions thereof.

As illustrated in FIG. 3, the lenticular luminescent assembly 10 includes conductors 60 and 62, such as metal foil conductors. The conductors 60 and 62 couple the rear capacitive electrode 44 and front conductive layer 52 to an electrical power source 70 such as, for example, a battery or electrical outlet. When suitable alternating current (AC) or pulsed direct current (DC) power is applied to the conductors 60 and 62, current flows between the capacitive plates (e.g., electrode 44 and conductive layer 52) energizing the EL phosphor layer 50 illuminating the EL light source 40 and backlighting the lenticular luminescent lens 20 and the visual effect of interest.

While not shown or described herein, it should be appreciated that it is within the scope of the present invention for the lenticular luminescent assembly 10 to be coupled to the electrical power source 70 via an inverter to convert between AC and DC power. Additionally, the assembly 10 may be coupled to the power source 70 through switches and/or timing circuitry to permit selective or timed illumination of the EL light source 40, the lenticular lens 20 and the visual effect of interest.

While the inventive backlighting assembly 10 has been described and illustrated in connection with preferred embodiments, many variations and modifications, as will be evident to those skilled in this art, may be made without departing from the spirit and scope of the invention. Accordingly, the invention is not to be limited to the precise details of methodology or construction set forth above as such variations and modification are intended to be included within the scope of the invention.

1. A system for backlighting a visual effect of interest, comprising:
a lenticular luminescent lens having a luminescent substance disposed thereon and/or therein for providing said visual effect of interest when exposed to stimulating light;
an electroluminescent (EL) light source affixed to a surface of said lenticular luminescent lens for providing an area of illumination about said visual effect of interest; and
a power source coupled to said EL light source;
wherein when said power source applies power to said EL light source, said EL light source activates said area of illumination backlighting said visual effect of interest.

2. The system of claim 1, wherein said lenticular luminescent lens includes a transparent synthetic resin material having said luminescent substance mixed therein/applied thereto.

3. The system of claim 2, wherein the transparent systetic resin material is selected from the group consisting of polycarbonate, polyvinyl chloride, polyester and mixtures thereof.

4. The system of claim 2, wherein the luminescent substance is benzoyltrifluroacetone.

5. The system of claim 1, wherein said EL light source includes:
a layer of core stock;
a rear capacitive electrode layer formed on said core stock layer;
a front capacitive electrode power distribution bus disposed on said core stock layer and electrically coupled to said rear capacitive electrode layer;
a capacitive dielectric insulation layer disposed on said core stock and encapsulating said rear capacitive electrode layer;
an EL phosphor layer disposed on said capacitive dielectric insulation layer; and
a light transmissive electrically conductive layer coupled to said front capacitive electrode power distribution bus;
wherein said EL phosphor layer and said capacitive dielectric insulation layer provide electrical isolation between said rear capacitive electrode layer and said light transmissive electrically conductive layer;
wherein when electrical power is applied, current flows between said rear capacitive electrode layer and said light transmissive electrically conductive layer energizing said EL phosphor layer, illuminating said EL light source and backlighting said visual effect of interest.

6. The system of claim 1, further comprising one of a switch and timing circuitry coupled to said power source for selectively illuminating said EL light source and said visual effect of interest.

7. The system of claim 1, further including a top layer over the lenticular luminescent lens, thereby providing protection from the environment.

8. The system of claim 1, wherein the EL light source further includes a light transmissive polyester film environmental incapsulation.

9. The system of claim 1, wherein the EL light source comprises an ITO paste or powder applied directly to a surface of the lenticular luminescent lens.
